(19) United States
(12) Patent Application Publication
(10) Pub. No.: US 2007/0229791 A1
(43) Pub. Date: Oct. 4, 2007

(54) Step Measuring Device and Apparatus, and Exposure Method and Apparatus

(75) Inventor: Jiro Inoue, Saitama-ken (JP)

Correspondence Address: OLIFF & BERRIDGE, PLC, P.O. BOX 19928, ALEXANDRIA, VA, 22320, US

(73) Assignee: nIkon Corporation, Tokyo (JP)

(21) Appl. No.: 10/593,083

(22) PCT Filed: Mar. 15, 2005
(86) PCT No.: PCT/JP05/04561

§ 371 Date: Oct. 2, 2006

(30) Foreign Application Priority Data
Mar. 16, 2004 (JP) 2004-074021

(51) Int. Cl. G03B 27/54

(52) U.S. Cl. 355/67; 356/600

(57) ABSTRACT

A step measuring method by which height distribution can be accurately measured in the case of exposing an object by a scanning exposure method, even when a plurality of areas having different heights due to steps exist in an asymmetrical distribution in a scanning direction on a surface of the object. Focus positions of same measuring points (26A, 26C) in a plurality of shot areas on a surface of a wafer (W) are measured, an inclination angle θxg of an reference plane (27) on the surface of the wafer (W) to an image plane (28) of a projection optical system is obtained, and the inclination angle of the wafer (W) is changed so as to offset the inclination angle θxg. Then, a shot area (SA7) to be measured is scanned to a measurement point row (32C) at the focus position, and the height distribution (step information) of the shot area (SA7) is obtained.

### TECHNICAL FIELD

The present invention relates to a step measuring technology for obtaining step information on a surface of an object such as a semiconductor wafer or a glass plate, and in a scanning exposure apparatus used for transferring a mask pattern on a substrate in a lithography process for manufacturing a device such as, for example, a semiconductor device, a liquid crystal display element, or a thin film magnetic head, it is suitable to be used for the surface of the substrate to be focused on an image plane in an autofocus system. Moreover, the present invention also relates to an exposure technology using the step measuring technology.

### BACKGROUND ART

Recently, as a semiconductor element etc. becomes more miniaturized, and a chip area becomes larger, a scanning exposure type projection exposure apparatus (scanning exposure apparatus) such as scanning stepper etc. has been used, where, by synchronously moving a reticle as a mask (or photomask etc.) and a wafer (or a glass plate etc.) coated with a photo resist as a substrate, with respect to a projection optical system, a pattern of the reticle is transferred to each shot area on the wafer. In the scanning exposure apparatus, individual shot areas on the wafer to be exposed have large areas, and the wafer is continuously scanned with respect to a slit-like exposure area on which an image of the reticle pattern is projected. Consequently, in a process where a focus position (a position in an optical axis direction in the projection optical system) of the surface of the wafer (wafer surface) is measured in the exposure area only, to focus the wafer plane with an image plane of the projection optical system in the autofocus system, since the stage side can not sufficiently follow the change of steps (unevenness) on the wafer surface, defocusing may occur partially. Accordingly, in the scanning exposure apparatus, a scheme has been proposed, where focus positions on the wafer surface are pre-read in an area preceding the exposure area (pre-read area) in the scanning direction, other than a predetermined measure point in the exposure area, and then, based on measured results of these focus positions, the wafer plane is focused on the image plane (for example, see Patent document 1, and Patent document 2).

Moreover, in the manufacture of a semiconductor device etc., it is also required to increase throughput, and the scanning speed of the reticle and the wafer in the scanning exposure apparatus gradually becomes higher. Consequently, when the stage is driven using only the focus position measured in the pre-read area and the exposure area during scanning exposure, if the step on the wafer surface is large, defocusing may occur partially. Further, if the individual shot areas on the wafer are divided into a plurality of areas having different heights due to steps (herein after referred to as “partial shots”), such an exposure step where only one partial shot among the plurality of partial shots is selectively exposed can be considered. In such an exposure step, it is desirable to perform offset correction with respect to focus positions measured in areas other than the partial shots to be exposed. Consequently, it is also proposed to correct the focus position measured during the scanning exposure, based on height distribution (unevenness distribution) information (shot topography), which is obtained by scanning the wafer alone, for example, before the scanning exposure, to measure focus positions at predetermined measure points in the pre-read area and the exposure area.

Patent document 1: Japanese Patent Application Laid-open No. 10-270300

Patent document 2: U.S. Pat. No. 6,090,510

### DISCLOSURE OF THE INVENTION

### Problems to be Solved by the Invention

As mentioned above, in the scanning exposure apparatus, it is proposed to use height distribution information of individual shot areas, during scanning exposure, which is obtained by preliminarily scanning the wafer alone before the scanning exposure. In such a case, conventional height distribution information has been information on difference of the focus position of each partial shot with respect to a reference plane that is set using, for example, an average plane in a height direction in one shot area. Consequently, when a reticle pattern is selectively exposed on a partial shot that is unevenly distributed in shot areas (located in areas being asymmetric with respect to the scanning direction) and has a height different from those of the other areas, even if a focus position to be measured during the scanning exposure is corrected using the preliminarily obtained height distribution information, exposure might be performed in a state where the surface of the partial shot was tilted with respect to the image plane of the projection optical system. Thus, when the surface of the partial shot to be exposed is tilted with respect to the image plane of the projection optical system, since a slit-like edge part in the exposure area becomes in a defocused state, when a pattern requiring a very high resolution is transferred, line width uniformity of the pattern on the entire partial shot etc. may decrease.

In addition, sometimes, conventional height distribution information has also been obtained using, for example, the widest partial shot in one shot area as a reference plane. However, in this case, it has been difficult to determine the reference plane in such a state where steps intricately and steeply change at a minute distance in one shot area, and a large number of small partial shots having different heights are scattered.

In view of such a point, the first object of the present invention is to provide a step measuring technology enabling to measure accurately height distribution of surfaces of areas having different heights due to steps, even when the areas are present in an asymmetric distribution on the surface an object such as a wafer.

Moreover, a second object of the present invention is to provide an exposure technology enabling to measure accurately height distribution of surfaces of areas having different heights due to steps, even if the areas are present in an asymmetric distribution on an object when the object is exposed, for example, in a scanning exposure system.

Further, a third object of the present invention is to provide an exposure technology enabling to perform the scanning exposure by focusing any area in a plurality of areas having different heights of the object on the image plane with high accuracy in the autofocus system.

### Means to Solve the Problems

The following parenthesized reference symbols appended to each element of the present invention, correspond to a configuration of an embodiments of the present invention described below. However, each reference symbol is only an example of the element, and is not intended to be limited to the configuration of the embodiment.

A first step measuring method according to the present invention, which is a step measuring method for obtaining step information on a surface of an object (W), includes a first step (steps 101 and 102) of obtaining tilt information on the surface of the object, a second step (step 103) of changing the tilt angle of the object based on the tilt information obtained in the first step, and a third step (step 106) of obtaining step information on the surface of the object while moving the tilt angle changed object.

According to such a present invention, for example, information of tilt angle of an average plane of the surface of the object can be obtained. Next, for example, the tilt angle of the object is changed such that the surface of the object becomes in parallel with the moving direction of the object as a whole. After that, step information of the surface of the object obtained by moving the object in the moving direction becomes information of height distribution, using the average plane of the surface as a reference plane. Accordingly, even if areas having different heights are present on the surface of the object in an asymmetric distribution with respect to the moving direction, it is possible to measure the height distribution (unevenness distribution) of the surface accurately, without being affected by local tilts of the surface.

Moreover, a second step measuring method according to the present invention is a measuring method for obtaining step information on the surface of an object (W), including a first step (steps 101 and 102) of obtaining tilt information of the surface of the object, a second step (step 106) of obtaining step information of the surface of the object while moving the object, and a third step (step 109A) of correcting the step information obtained in the second step based on the tilt information obtained in the first step.

In the present invention, for example, after information of tilt angle of the average plane of the surface of the object is obtained, step information of the surface of the object can be obtained without changing the tilt angle of the object. After that, by correcting the step information so as to be information of height distribution using the average plane of the surface as a reference plane, the height distribution of the surface can be measured accurately, without being affected by local tilts of the surface.

In these present inventions, if the surface of the object is divided into a large number of sectional areas (SAi) mutually having a same shape, the first process may include a measuring step of measuring height information of measure points (26A, 26B and 26C) that are mutually in a same positional relationship in a plurality of the sectional areas selected from the large number of the sectional areas of the object, and a calculating step of obtaining tilt information on the surface of the object based on the height information measured in the measuring step. This enables to obtain information of the tilt angle of the average plane of the surface of the object accurately, without being affected by local tilts of the surface.

Next, a first exposure method according to the present invention is an exposure method for scanning and exposing a second object (W) by illuminating the second object via a first object (R) with an exposure beam and by synchronously moving the first object and the second object, which includes a first step (steps 101 and 102) of obtaining tilt information of the surface of the second object, a second step (step 103) of changing the tilt angle of the second object based on the tilt information obtained in the first step, and a third step (step 106) of obtaining step information, which is to be used in scanning and exposing the second object, of the surface of the second object while moving the tilt angle changed second object.

According to the present invention, the step information obtained in the third process is, for example, information of height distribution using an average plane of the surface of the second object as a reference plane. Therefore, when the exposure of the second object is performed in the scanning exposure system, even if a plurality of areas having different heights are present on the surface of the second object in an asymmetric distribution in the scanning direction, it is possible to measure the height distribution accurately, without being affected by local tilts of the surface.

Moreover, a second exposure method according to the present invention is an exposure method for scanning and exposing a second object (W) by illuminating the second object via a first object (R) with an exposure beam and by synchronously moving the first object and the second object, which includes a first step (steps 101 and 102) of obtaining tilt information of the surface of the second object, a second step (step 106) of obtaining step information, which is to be used in scanning and exposing the second object, of the surface of the second object while moving the second object, and a third step (step 109A) of correcting the step information obtained in the second process based on the tilt information obtained in the first process.

According to the present invention, in the third step, the step information obtained in the second step is corrected so as to be, for example, information of height distribution using an average plane of the surface of the second object as a reference plane. Therefore, it is possible to measure the height distribution of the second object accurately, without being affected by local tilts of the surface of the second object.

In the exposure method of the present invention, as one example, the surface of the second object is divided into a large number of sectional areas (SAi) on each of which a pattern of the first object is to be transferred, and the first step includes a measuring step of measuring height information of measure points (26A, 26B and 26C) that are mutually in a same positional relationship in a plurality of the sectional areas selected from the large number of the sectional areas of the second object, and a calculating step of obtaining the tilt information of the surface of the second object based on the height information measured in the measuring step. This enables to obtain information of tilt angle of the average plane of the surface of the second object correctly.

Moreover, the exposure method may further include a fourth step (steps 113, 114 and 115) of scanning and exposing the second object, while focusing the surface of the second object onto an image plane of a pattern of the first object, based on information obtained by measuring height information on the surface of the second object while synchronously moving the first object and the second object and correcting the measured height information using the step information corrected in the third step. This enables to perform the scanning exposure of the second object, when a plurality of areas having different heights are present in each sectional area on the surface of the second object, by focusing any area in the plurality of areas on the image plane with high accuracy in the autofocus system. As a result, it is possible to improve the uniformity of the size and the line width of the transferred pattern in the entire surface of each sectional area on the second object.

Next, a step measuring apparatus according to the present invention is a step measuring apparatus for obtaining step information on a surface of an object (W), which includes: a stage device (WST) which moves at least in a first direction while holding the object and controls at least one of a height and a tilt angle of the object; a sensor (19A and 19B) which measures height information of the object held by the stage device; and an arithmetic device (8) which obtains tilt information of the surface of the object based on the height information measured by the sensors when the object is moved via the stage device, and obtains the step information on the surface of the object, based on the tilt information and the height information measured by the sensor when the object is moved in the first direction via the stage device. According to the invention, the step measuring method of the present invention can be used.

In this case, as one example, the arithmetic device has a function, after changing the tilt angle of the object via the stage device based on the tilt information of the surface of the object, to obtain the step information of the surface of the object based on the height information measured by the sensor when the object is moved in the first direction via the stage device.

Moreover, as another example, the arithmetic device has a function, after obtaining the tilt information of the surface of the object, to obtain the step information of the surface of the object by correcting the height information, by using the tilt information, of the object measured by the sensor when the object is moved in the first direction via the stage device.

Moreover, a first exposure apparatus according to the present invention is an exposure apparatus for scanning and exposing a second object by illuminating the second object (W) via a first object (R) with an exposure beam and synchronously moving the first object and the second object, which includes: a stage device (WST) which holds the second object and moves the second object at least in a first direction, and controls at least one of a height and a tilt angle of the second object; a sensor (19A and 19B) which measures height information of the second object held by the stage device; and an arithmetic device (8) which obtains tilt information of a surface of the second object based on the height information measured by the sensor when the second object is moved via the stage device, and obtains step information on the surface of the second object based on the tilt information and the height information measured by the sensor when the second object is moved in the first direction via the stage device. According to the invention, the exposure method of the present invention can be used.

In this case, as one example, the arithmetic device has a function, after changing the tilt angle of the second object via the stage device based on the tilt information of the surface of the second object, to obtain the step information of the surface of the second object based on the height information measured by the sensor when the second object is moved in the first direction via the stage device.

Moreover, as another example, the arithmetic device has a function, after obtaining the tilt information of the surface of the second object, to obtain the step information of the surface of the second object by correcting the height information, by using the tilt information, of the second object measured by the sensor when the second object is moved in the first direction via the stage device.

Moreover, if the surface of the second object is divided into a large number of sectional areas (SAi) on each of which a pattern of the first object is to be transferred, the arithmetic device may obtain the tilt information of the second object based on height information measured by the sensor at measure points (26A, 26B and 26C) that are mutually in a same positional relationship in a plurality of sectional areas selected from the large number of sectional areas of the second object.

Moreover, a second exposure apparatus according to the present invention is an exposure apparatus for scanning and exposing the second object by illuminating the second object (W) via a first object (R) with an exposure beam and synchronously moving the first object and the second object, which includes: a stage device (WST) which holds the second object and moves the second object at least in a first direction, and controls at least one of a height and a tilt angle of the second object; a sensor (19A and 19B) which measures height information of the second object held by the stage device; a memory device (22) which stores step information on a surface of the second object corrected based on tilt information of the surface of the second object; and a control device (8) which controls, during scanning and exposing the second object, an attitude of the second object by driving the stage device based on the step information stored in the memory device and the height information measured by the sensor.

According to the present invention, it is possible to perform the scanning exposure of the second object by using the step information stored in the memory device to focus the surface of the second object on the image plane with high accuracy in the autofocus system.

Moreover, as one example, the surface of the second object includes a plurality of planes (29A, 29B, and 29C) having different heights from each other, and the control device has a function to control the attitude of the second object by driving the stage device such that a predetermined plane selected from the plurality of planes having different heights from each other is focused on an image plane of a pattern of the first object. This enables to cause any plane among the plurality of planes to be focused on the image plane in the autofocus system.

### EFFECT OF THE INVENTION

According to the present invention, even if areas having different heights due to steps are present on the surface of the object or the second object in an asymmetric distribution, it is possible to measure the height distribution of the surface accurately.

Moreover, according the exposure method and apparatus of the present invention, when exposing the object in the scanning exposure system, even if the plurality of areas having different heights due to steps are present on the surface of the second object in the scanning direction in an asymmetric distribution, it is possible to measure the height distribution accurately.

Further, by driving the stage device using the measured information of the steps, it is possible to perform the scanning exposure of the second object by focusing any area among the plurality areas having different heights of the surface of the second object onto the image plane with high accuracy in the autofocus manner.

### BRIEF DESCRIPTION OF THE FIGURES IN THE DRAWINGS

FIG. 1 is a view showing the schematic configuration of a projection exposure apparatus according to embodiments of the present invention.

FIG. 2 is a perspective view showing coordinate measuring system and a multi-points AF sensor of a wafer table 11 of the projection exposure apparatus in FIG. 1.

FIG. 3 is a view showing an example of an arrangement of measure points for focus position according to a first embodiment of the present invention.

FIG. 4 is a view showing another example of an arrangement of measure points for focus position according to the first embodiment.

FIG. 5 is a plan view showing a shot arrangement of wafer exposed according to the first embodiment.

FIG. 6 (A) is an enlarged sectional view along a line passing through the measure points 26A and 26C of the wafer in FIG. 5, FIG. 6 (B) is a view showing a state where the wafer of the FIG. 6 (A) is tilt so as to balance out the global tilt angle, FIG. 6 (C) is a partially enlarged view of FIG. 6 (B), FIG. 6 (D) is a view showing a correction map CZ1 (m, n) obtained in the first embodiment, and FIG. 6(E) is a view showing a correction map CZ2(m, n) obtained in the first embodiment.

FIG. 7 (A) is an enlarged sectional view showing a tilt state of a shot area SA7 during measuring height distribution, in a second embodiment of the present invention, FIG. 7 (B) is a view showing a correction map CZ1(m, n) obtained in the second embodiment, and FIG. 7 (C) is a view showing a correction map CZ2(m, n) obtained in the second embodiment.

FIG. 8 is a flowchart showing an example of an exposure operation according to the first embodiment of the present invention.

FIG. 9 is a plain view provided for describing an exposure operation with respect to a wafer W according to the first embodiment.

FIG. 10 is an enlarged perspective view showing the height distribution of the shot area SAi on the wafer.

FIG. 11 is an enlarged perspective view showing a state where a partial shot in the shot area SAi on the wafer is tilt with respect to an image plane.

FIG. 12 is a flowchart showing an example of an exposure operation according to the second embodiment of the present invention.

### DESCRIPTION OF THE SYMBOLS

R: Reticle
PL: Projection optical system
W: Wafer
WST: Wafer stage system
3: Exposure area
4: Reticle stage
8: Main control system
11: Wafer table
12A to 12C: Z drivers
13: XY stage
19A: Irradiation optical system of multiple AF sensor
19B: Light receiving optical system of multiple AF sensors
21A, 21B: Pre-read areas
22: Memory device
27: Reference plane
28: Image plane
29A to 29C: Partial shots
31: Measure point
32A to 32E: Measure points rows
SAi: Shot areas

### BEST MODE FOR CARRYING OUT THE INVENTION

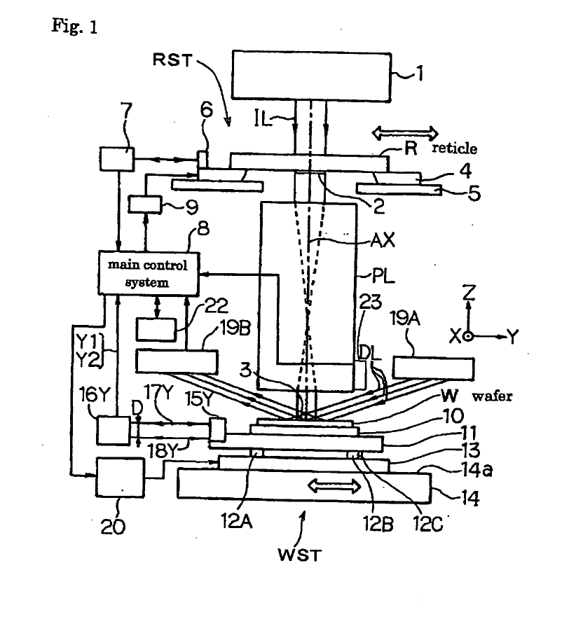

Hereinafter, referring to FIGS. 1 to 11, a preferable first embodiment of the present invention will be described. The present embodiment is an example to which the present invention is applied, when exposure is performed using a scanning exposure type projection exposure apparatus (scanning exposure apparatus) composed of a scanning stepper.

FIG. 1 shows a projection exposure apparatus of the present embodiment, and although not shown in FIG. 1, as an exposure light source, an excimer laser light source such as KrF excimer laser (wavelength 248 nm) or ArF excimer laser (wavelength 193 nm), an F₂ laser light source (wavelength 157 nm), a harmonic generator of a YAG laser or other solid laser (a semiconductor laser etc.), or a mercury lamp etc. may be used. During exposure, exposing light IL as exposing beam from the exposing light source illuminates an illumination area 2 of a patterning plane (lower plane) of a reticle R as a mask, in uniform illuminance distribution through an illumination optical system 1. The illumination optical system 1 includes a light quantity controller, an optical integrator (uniformizer or homogenizer) such as a fly's-eye lens, an aperture stop, a field stop, and a condenser lens etc.

Under the exposing light IL, the image of the pattern in an illumination area 2 of the reticle R is projected and exposed in an exposure area 3 on a wafer W coated with a photoresist as a substrate with a predetermined projection magnification β (β is ¼ or ⅕ etc.) through a projection optical system PL. The reticle R and the wafer W can also be considered as a first object and a second object (or simply object), respectively. The wafer W is, for example, a disk-shaped substrate having a diameter of an order of 200 to 300 mm made of semiconductor (silicon etc.), SOI (silicon on insulator) or the like. Hereinafter, description will be made by setting Z axis to be in parallel with an optical axis AX of the projection optical system PL, X axis to be perpendicular to the page of FIG. 1 in a plane perpendicular to the optical axis AX, and Y axis to be in parallel with the page of FIG. 1. The scanning direction of the reticle R and the wafer W during the scanning exposure in the present embodiment, is a direction being in parallel with the Y axis (Y direction), and the illumination area 2 of the reticle R and the exposure area 3 on the wafer W are rectangular areas respectively elongated in a direction being in parallel with the X axis (X direction) that is non-scanning direction perpendicular to the scanning direction.

First, the reticle R is held on a reticle stage 4 by means of vacuum adsorption etc., and the reticle stage 4 is placed on a reticle base 5 through an airbearing. The reticle stage 4 continuously moves on the reticle base 5 in Y direction (scanning direction) by means of a driving system 9 including a linear motor etc., and stirs in the X direction, the Y direction, and a rotational direction around the Z axis to fine adjust the position of the reticle R. The two dimensional position of the reticle stage 4 (the reticle R) is measured with a moving mirror 6 on the reticle stage 4 and an external laser interferometer 7, and the measured value is supplied to a stage controller in a main control system 8 including a computer totally controlling the entire operation of the apparatus. The stage controller controls the position and the moving speed of the reticle stage 4 based on the measured value via the driving system 9. A reticle stage system RST is configured by including the reticle stage 4, the reticle base 5, the moving mirror 6, and the driving system 9.

Meanwhile, the wafer W is held on a wafer table 11 (sample table) by means of vacuum adsorption etc. via a wafer holder 10, and the wafer table 11 is fixed on an XY stage 13 via three Z drivers 12A, 12B and 12C that can be driven in the Z direction within a predetermined range. As the Z drivers 12A to 12C, for example, a voice coil motor-driving mechanism or an expansion and contraction mechanism using a piezoelectric element etc. can be used. An autofocus controller in the main control system 8 controls the driving of the Z drivers 12A to 12C, driving the Z drivers 12A to 12C by the same amount controls the position in the Z direction (focus position) of the wafer W, and driving the Z drivers 12A to 12C by different amounts controls (leveling) the tilt angles around the X axis and the Y axis of the wafer W. At that time, information of focus position on the surface of the wafer W measured by the below-mentioned autofocus sensors is used. When the surface of the wafer W is a substantially flat plane, the Z drivers 12A to 12C are driven with the autofocus system such that the surface coincides with the image plane of the projection optical system PL within a predetermined range. An example of control method when steps are present on the surface of the wafer W will be described below.

Moreover, the XY stage 13 is placed on an upper surface 14a (hereinafter referred to as “guide surface”) on a wafer base 14 composed of a surface plate through the airbearing. The XY stage 13 can move continuously in the Y direction on the guide surface 14a by means of a driving system 20 including a linear motor etc., and can make a step movement in the X direction and in the Y direction.

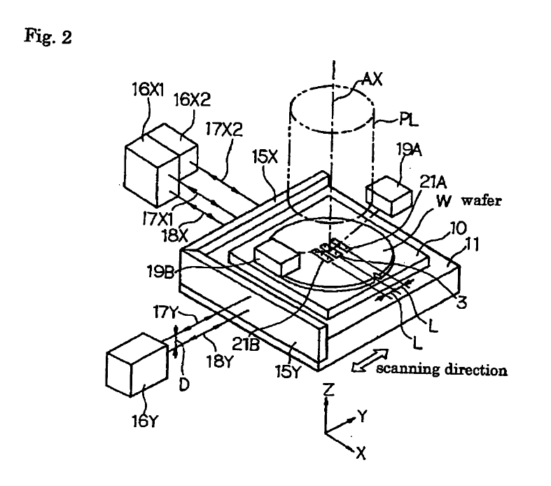

In order to measure the coordinate of the wafer table 11 (the XY stage 13), a moving mirror 15X (see FIG. 2) for the X axis having a reflection surface substantially perpendicular to the X axis, and a moving mirror 15Y for the Y axis having a reflection surface substantially perpendicular to the Y axis are fixed to the upper end of the wafer table 11. In addition, in place of the moving mirrors 15X and 15Y, reflective surfaces formed on the sides of the wafer table 11 can be used.

FIG. 2 shows a coordinate measuring system of the wafer table, and in FIG. 2, from a biaxial laser interferometer 16Y for the Y axis to the moving mirror 15 Y for the Y axis, two measuring laser beams 17Y and 18Y are irradiated in parallel along the Y axis with a distance D in the Z direction, and the laser beams 17Y and 18Y reflected by the moving mirror 15Y are returned to the laser interferometer 16Y. In the laser interferometer 16Y, by means of photo-electron detection of interference light of the returned laser beams 17Y and 18Y and corresponding laser beams reflected by a reference mirror (not shown) on the side of the projection optical system PL, Y coordinates Y1 and Y2 at two points of the moving mirror 15Y are detected. These Y coordinates Y1 and Y2 are supplied to a stage control system in the main control system 8 in FIG. 1. The stage control system obtains a rotation angle (pitching) around the X axis of the wafer table 11, by using the average value of these Y coordinates Y1 and Y2 as a Y coordinate of the moving mirror 15 Y, consequently the wafer table 11, and the difference between these two Y coordinates Y1 and Y2.

Moreover, in FIG. 2, from a biaxial laser interferometer 16X1 for the X axis to the moving mirror 15X for the X axis, two measuring laser beams 17X1 and 18X are irradiated in parallel along the X axis with a distance D in the Z direction, and the laser beams 17X1 and 18X reflected by the moving mirror 15X are returned to the laser interferometer 16X1. In the laser interferometer 16X1, by means of photo-electron detection of interference light of the returned laser beams 17X1 and 18X and corresponding laser beams reflected by a reference mirror (not shown) on the side of the projection optical system PL, X coordinates X1 and X2 at two points of the moving mirror 15X are detected. Further, from another laser interferometer 16X2 for the X axis to the moving mirror 15X, a laser beam 17X2 is irradiated at a predetermined distance from the laser beam 17X1 in the Y direction and in parallel with the X axis, and at the irradiated point of the laser beam 17X2, an X coordinate X3 of the moving mirror 15X is also measured. These X coordinates X1 to X3 are supplied to the stage control system in the main control system 8 in FIG. 1, and the stage control system uses, for example, the average value of the X coordinates X1 and X2 as an X coordinate of the moving mirror 15X, consequently the wafer table 11. Further, the stage control system calculates the rotation angle (rolling) around the Y axis of the wafer table 11 from the difference between the X coordinates X1 and X2, and calculates the rotation angle (yawing) around the Z axis of the wafer table 11 from the difference between the X coordinates X1 and X3.

In the present embodiment, the optical axis AX of the projection optical system PL is present on the extension of laser beams 17X1 and 18X for the X axis, and on the extension of laser beams 17Y and 18Y for the Y axis, and it is configured such that an Abbe error does not occur at the X and Y coordinates of the wafer table 11 to be measured. Returning to FIG. 1, the stage control system in the main control system 8 controls the moving speed and positioning operation of the XY stage 13 via the driving system 20 based on the position of the wafer table 11 measured via the laser interferometers 16X1, 16X2 and 16Y in FIG. 2. At that time, as one example, the XY stage 13 is driven such that the above-mentioned pitching, rolling, and yawing fall within a predetermined range. A wafer stage system WST is configured by including the wafer holder 10, the wafer table 11, the moving mirrors 15X and 15Y, the Z drivers 12A to 12C, the XY stage 13, the wafer base 14, and the driving system 20. The wafer stage system WST corresponds to a stage device moving while holding the wafer W (the second object).

Moreover, to the main control system 8, a memory device 22 such as a magnetic disk device for storing various kinds of exposure data etc. is also connected. Further, on the side of the projection optical system PL, in order to detect the position information of alignment marks (wafer marks) annexed to each shot area on the wafer W, an image processing type and off axis type alignment sensor 23 is arranged. The position information detected by the alignment sensor 23 is supplied to an alignment controller in the main control system 8, and the alignment controller obtains arrangement coordinates of each shot area on the wafer W, based on the position information. Moreover, above the reticle stage 4, a reticle alignment microscope (not shown) is arranged for measuring the positional relationship between alignment marks of the reticle R and corresponding reference marks (not shown) on the wafer table 11. The detected information of the reticle alignment microscope is also supplied to the alignment controller in the main control system 8, and the alignment controller aligns the reticle R and the wafer W based on these information.

During exposure, after the reticle R and the wafer W are aligned first, the height distribution (step information) on the surface of the wafer W is measured (the detail will be described below). After that, an operation for driving the XY stage 13 to step move the wafer W (the wafer table 11) in the X direction and in the Y direction, and a scanning exposure operation are repeated. The scanning exposure operation scans one shot area (sectional area) with respect to the exposure area 3 in the Y direction at a speed of β·VR (β is a projection magnification of the projection optical system) through the XY stage 13 in synchronization with scanning the reticle R with respect to the illumination area 2 of the exposing light IL in the Y direction at a speed of VR through the reticle stage 4. In this manner, a pattern image of the reticle R is transferred to the entire shot areas on the wafer W in a step and repeat system.

As mentioned above, during the scanning exposure of the wafer W, the autofocus controller in the main control system 8 drives the Z drivers 12A to 12 C in the autofocus system so as to focus the surface of the wafer W (focused) on the image plane of the projection optical system PL. Consequently, the projection exposure apparatus in FIG. 1 of the present embodiment is equipped with oblique incidence optical system multipoint autofocus sensors (hereinafter, referred to as “multipoint AF sensor”) (19A and 19B) for measuring the focus position (position or height in Z direction) on the surface of the wafer W. The multipoint AF sensors (19A and 19B) correspond to sensors for measuring height information of the wafer W (the second object).

In FIG. 1, the multipoint AF sensors (19A and 19B) are composed of an irradiation optical system 19A and a light-receiving optical system 19B. Then, under detecting light DL that is not photo-sensitive to a photoresist, from the irradiation optical system 19A, a plurality of slit images is projected on a plurality of measure points on the wafer w obliquely to the optical axis AX of the projection optical system PL. As shown in FIG. 2, these measure points are set in the inside of the exposure area 3, in a pre-read area 21A apart from the center of the exposure area 3 by a distance L in +Y direction and in a pre-read area 21B apart from the center of the exposure area 3 by the distance L in −Y direction.

Returning to FIG. 1, reflected light from the measure points re-images the slit images corresponding to the measure points on a plurality of photoelectric conversion elements in the light-receiving optical system 19B through, for example, a vibrating slit plate. By synchronously rectifying the detected signals from the photoelectric conversion elements using, for example, a driving signal for the vibrating slit plate, focus signals changing substantially in proportion to focus positions at the corresponding measure points within a predetermined range are generated, and the focus signals are supplied to the autofocus controller in the main control system 8. In the present embodiment, each focus signal corresponding to the measure point in the exposure area 3 is calibrated in advance so that each focus signal becomes zero when the corresponding measure points are coincident with the image plane (best focus position) of the projection optical system PL, the auto focus controller in the main control system 8 can obtain defocused amount from the image plane to the Z direction at the corresponding measure point, from each focus signal. Additionally, examples of specific configuration of the oblique incidence type multipoint AF sensors (19A and 19B) are disclosed in, for example, Japanese Patent Application Laid Open Publication No. 10-270300 (corresponding U.S. Pat. No. 6,090,510).

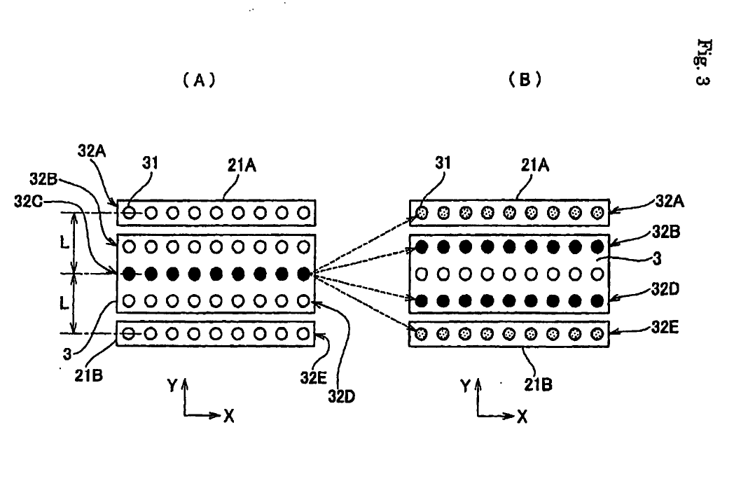

FIG. 3 (A) shows an example of arrangement of the measure points 31 at focus positions of the multipoint AF sensors (19A and 19B) of the present embodiment, in FIG. 3 (A), three rows of measure points 32B, 32C and 32D which are composed of nine measure points 31 each arranged in the X direction at a constant pitch, respectively, and arranged in the Y direction at an equal distance, are set in the exposure area 3, and the central measure points row 32C passes through the optical axis AX of the projection optical system PL of FIG. 1. Moreover, in the pre-read area 21A being in +Y direction with respect to the exposure area 3, measure points row 32A composed of 9 measure points 31 arranged in the X direction at a constant pitch is set, and in the pre-read area 21B being in −Y direction with respect to the exposure area 3, measure points row 32E composed of 9 measure points 31 arranged in the X direction at a constant pitch is also set. Distances from the measure points rows 32A and 32E being both ends in the Y direction (scanning direction) to the central measure points rows 32C, are set to be L respectively. Slit images are projected on the nine columns×five rows measure points 31 from the multipoint AF sensors (19A and 19B) in FIG. 1 respectively, and the focus position of each measure point 31 is measured at a predetermined sampling rate, respectively. The number and the array of the measure points 31 are arbitrary.

In this case, in FIG. 2, if the scanning exposure is performed by moving the wafer W in −Y direction with respect to the exposure area 3, in the autofocus controller in the main control system 8 in FIG. 1, using position information in the Y direction of the wafer W, focus position information at the measure points in the exposure area 3 and the pre-read area 21A at a side in +Y direction, and a correction map (to be described later) at a focus position preliminarily obtained, focus position ZW for the wafer W, tilt angle ΦX of the wafer W around X axis, and tilt angle ΦY of the wafer W around Y axis to focus the surface of the wafer W in the exposure area 3 on the image plane of the projection optical system PL, are calculated in a predetermined rate, to set, from the values, displacement amounts of the Z drivers 12A to 12C in FIG. 1. At that time, as one example, since the focus position and the tilt angle of the wafer W are set in advance based on the focus position measured in the pre-read area 21A, and the focus position and the tilt angle are corrected by a follow-up control based on the focus position measured in the exposure area 3, follow-up accuracy with respect to the image plane of the surface of the wafer W increases.

Meanwhile, when the scanning exposure is performed by moving the wafer W in +Y direction with respect to the exposure area 3, by continuously detecting the focus position at a measure point in the exposure area 3 and the focus position at a measure point in the pre-read area 21B at a side in −Y direction, the surface of the wafer W is focused on its image plane in the autofocus system. Moreover, in the present embodiment, as described below, although height distribution on the surface of the wafer W is obtained in advance, in this case, as one example, the focus position of the wafer W may be measured using only a measure point of the central measure points row 32C in the exposure area 3 in FIG. 3 (A) in a state where the wafer W is moved in +Y direction or −Y direction. In addition, during the scanning exposure, when the wafer W is scanned in −Y direction, as shown in FIG. 3 (B), the focus position of the wafer W may be measured at only the measure positions 31 of the measure points row 32A in the pre-read area 21A in +Y direction and the measure points row 32B in the exposure area 3 in +Y direction. In this case, when the wafer W is scanned in +Y direction, as shown in FIG. 3 (B), the focus position of the wafer W is measured at only the measure positions 31 of the measure points row 32E in the pre-read area 21B in −Y direction and the measure points row 32D in the exposure area 3 in −Y direction. This enables to perform arithmetic processing easier than in the case using focus positions at all measure points 31 with few degradation of follow-up accuracy during autofocusing.

In addition, as in the present embodiment, when height distribution of the wafer W is obtained in advance, it is not always necessary to set the pre-read areas 21A and 21B. In contrast, it is also possible to measure the focus position only in the pre-read areas 21A and 21B without measuring the focus position in the exposure area 3. Moreover, the focus position may be measured at least one row of measure points of the measure points rows 32B, 32C and 32D.

Next, in a case where a plurality of steps occurs in each shot area on the wafer W due to previous device manufacturing processes, and the distribution of areas having different heights (partial shots) in each shot area is deflected in the Y direction (scanning direction) to be asymmetric, an example of exposure processes when exposure is performed by focusing a partial shot having a predetermined height in each shot area on the image plane of the projection optical system PL in the auto focus system, will be described. The exposure process is required, for example, when an image with a fine pattern such as a contact hole is exposed on a predetermined partial shot in each shot area.

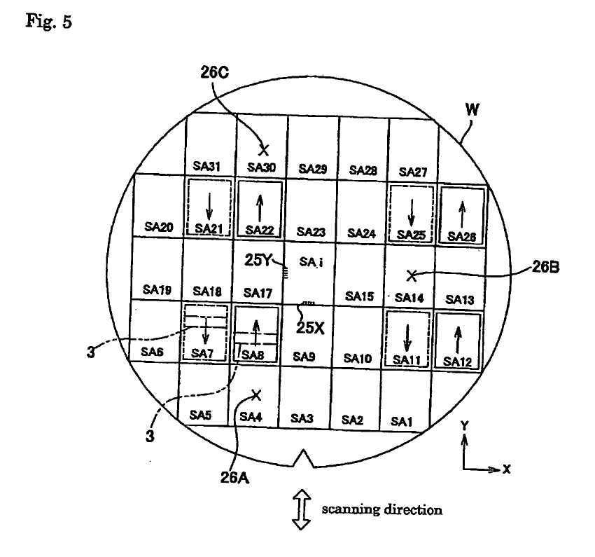

FIG. 5 shows an example of such a wafer W, and in FIG. 5, the surface of the wafer W is divided into shot areas SA1 to SA31 as a large number of sectional areas at a predetermined pitch in the X direction and in the Y direction. The wafer W is, for example, a head wafer of one lot of wafers to be exposed. In addition, in FIG. 5, although number of the shot areas is 31, the number and array pitch are arbitrary. If the i-th shot area on the wafer W is denoted as SAi (i=1 to 31), in each shot area SAi, a wafer mark 25X of the X axis and a wafer mark 25Y of the Y axis are formed through previous device manufacturing processes, and predetermined circuit patterns identical to each other are formed. Consequently, height distributions (unevenness distributions) due to steps in each shot area SAi are also identical to each other. In addition, the surface of the wafer W is practically covered with a photoresist layer (not shown).

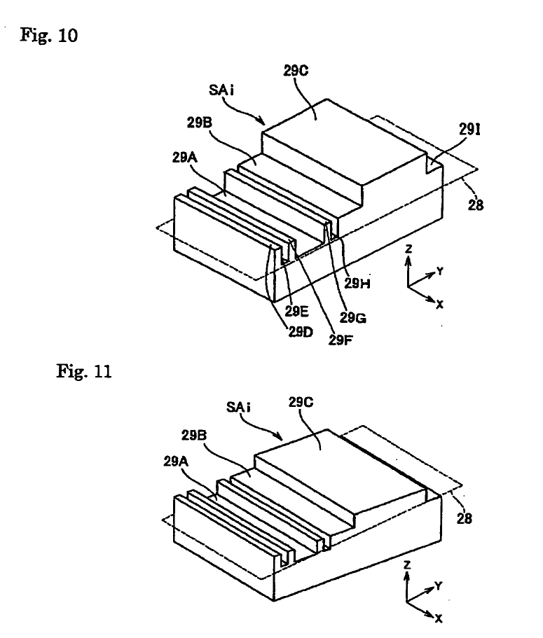

FIG. 10 is an enlarged perspective view showing an example of steps of the surface of the shot area SAi on the wafer W, in FIG. 10, the surface of the shot area SAi is divided into partial shots 29D to 29F, 29A, 29G, 29H, 29B, 29C, and 29I in the Y direction (scanning direction) by a plurality of steps. Among these shots, focus positions (positions in Z direction, i.e. heights) of three partial shots 29A, 29B and 29C occupying a major part of area, become gradually higher, thus, the height distribution deflects in the scanning direction. Accordingly, if the surfaces of the partial shots 29A to 29C are substantially perpendicular to Z axis, as shown in FIG. 11, the average plane of the shot area SAi is a surface tilt around X axis with respect to a plane being in parallel with the partial shots 29A to 29C. At the situation, if an image with a fine pattern is intended to be transferred on, for example, the lowest partial shot 29A, it is desirable to cause the partial shot 29A and the image plane 28 of the projection optical system PL in FIG. 1 to be in parallel with each other. For this purpose, it is necessary to measure information of height distribution (unevenness distribution) of the surface of the shot area SAi, in advance. Further, on the occasion of the measurement, it is necessary to determine a reference plane to be a reference of height with respect to the wafer W.

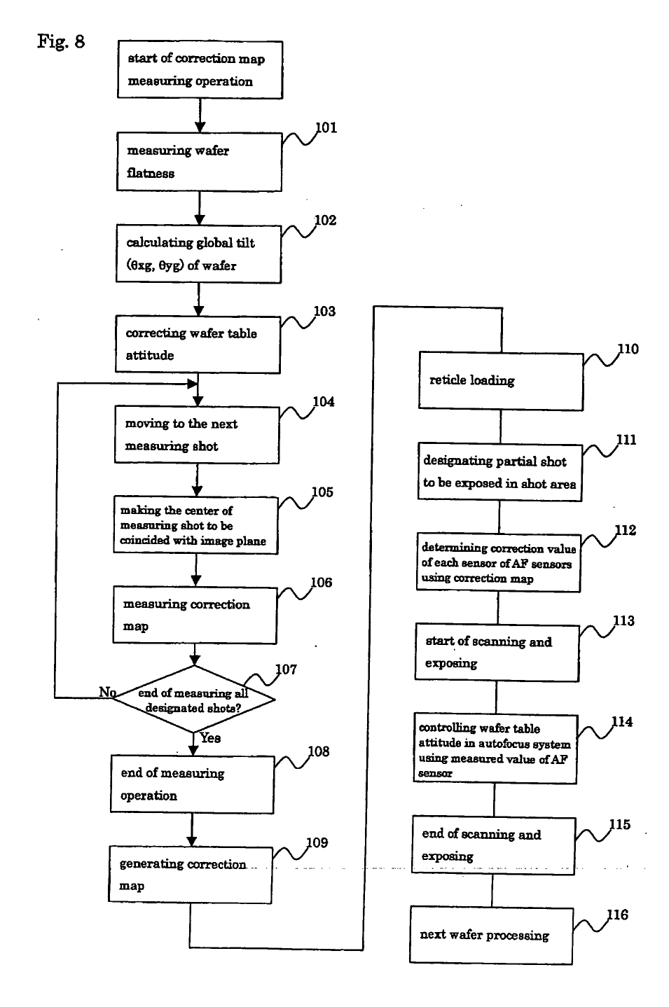

Hereinafter, referring to a flowchart in FIG. 8, an example of exposure processes of the present embodiment will be described. First, measurement of the correction map for focus position is started. In other words, in a step 101 in FIG. 8, a wafer W in FIG. 5 is loaded on a wafer table 11 of the projection exposure apparatus in FIG. 1, through a wafer holder 10. The following operation is totally controlled by an exposure controller in the main control system 8. After that, by measuring X and Y coordinates of the wafer marks 25X and 25Y respectively annexed to, for example, about eight shot areas on the wafer W using an alignment sensor 23, X coordinates and Y coordinates of centers of all of the shot area SAi (i=1 to 31) are calculated. After that, in order to set a reference plane during measuring the height distribution in the shot area SAi, flatness of the wafer W is measured.

Consequently, in FIG. 5, three shot areas SA4, SA14 and SA30 that are not on the same line are selected from the wafer W as flatness measuring shots, and positions in flatness measuring shots being identical to each other, in the present embodiment, centers of the shot areas SA4, SA14 and SA30 are set as measure points 26A, 26B and 26C. In addition, in the present embodiment, the positions in each flatness measuring shot being identical to each other are coincided with the center of a predetermined partial shot 29B (see FIG. 10) in each shot area SAi. In this case, the shot areas SA4 and SA30 depart from each other in the Y direction, and another shot area SA14 departs in the X direction with respect to the shot areas. In the present embodiment, a plane including the measure points 26A, 26B and 26C on the wafer W becomes a reference plane, and as described below, tilt angles of the reference plane around X axis and Y axis (global tilt angle) are obtained as tilt information.

For this purpose, the number of the measure points 26A to 26C, i.e. the number of the flatness measuring shots needs to be at least three. Moreover, in order to increase the accuracy of the tilt information by an averaging effect, by setting the number of the flatness measuring shots to be four or more, by means of, for example, a least-square method, tilt angles of the reference plane around two axes may be obtained. In this case, it is preferable to arrange the flatness measuring shots on the surface of the wafer W without deflection, for example, to arrange one flatness measuring shot to each quadrant with respect to the center of the wafer W. Moreover, the flatness measuring shots may be identical to shot areas for measuring height distribution in the below-described shot areas.

After that, by driving the XY stage 13 in FIG. 1, the measure points rows 26A, 26B and 26C are sequentially moved to, for example, the center measure point of the center measure points row 32C in the exposure area 3 among measure points 31 in FIG. 3 (A), thereby, deflections GZ1, GZ2 and GZ3 in the Z direction (height information) with respect to the image plane of the projection optical system PL are measured respectively. In the situation, the Z drivers 12A to 12C of the wafer stage system WST in FIG. 1 are fixed to, for example, the center in a driving stroke, so as not to be driven. The deflections GZ1 to GZ3 are supplied to a correction map calculator (arithmetic device) in the main control system 8 in FIG. 1.

In the next step 102, in the correction map calculator, using the deflections GZ1 to GZ3 and X coordinates and Y coordinates of the measure points 26A to 26C, the reference plane (approximation plane when the number of measure points is more than three) of the wafer W passing through the measure points 26A to 26C is calculated, and a tilt angle θxg around the X axis and a tilt angle θyg around the Y axis of the reference plane are stored as the global tilt angle (θxg, θyg) (tilt information). The above-mentioned process corresponds to a process for obtaining tilt information of the surface of the object (second object).

In next step 103, the information of the global tilt angle (θxg, θyg) is supplied to the autofocus controller in the main control system 8, in the autofocus controller, by driving the Z drivers 12A to 12C, tilt angles around the X axis and the Y axis of the wafer table 11 are set to angles (−θxg, −θyg) that balances out the respective corresponding global tilt angles.

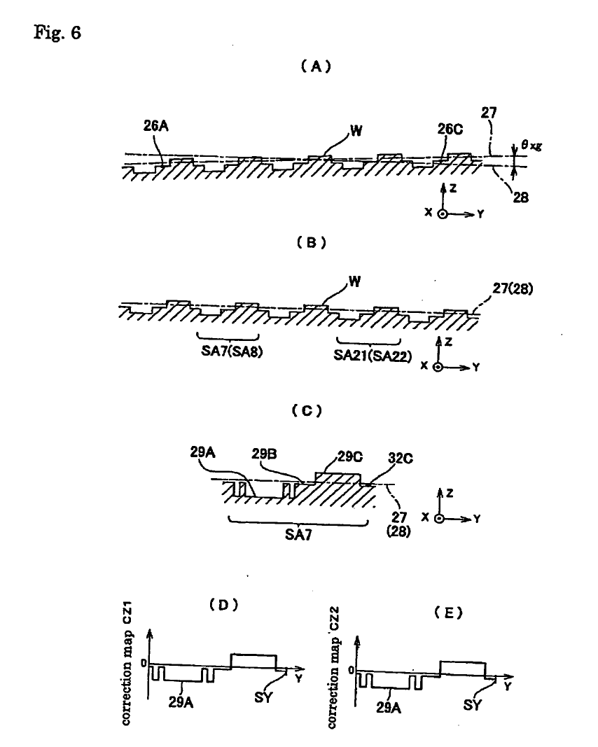

FIG. 6 (A) is an enlarged sectional view of a main part showing the state of the wafer W before the attitude of the wafer table 11 is changed, and as shown in FIG. 6 (A) a reference plane 27 passing through the measure points 26A to 26C on the wafer W is tilt with respect to the image plane 28 of the projection optical system PL around X axis at a tilt angle θxg. In the present embodiment, since the wafer table 11 is tilt so as to balance out the tilt angle θxg (much the same for the tilt angle around Y axis), as shown in the enlarged sectional view In FIG. 6 (B), in the state of the wafer W after the wafer table 11 is tilt, the reference plane 27 is in parallel with the image plane 28. In addition, although, in FIG. 6 (B), cross-sections of a plurality of shot areas containing two shot areas SA7 and SA21 (or SA8 and SA22) appear, the sectional shapes of these shot areas are identical to each other.

In next steps 104 to 107, height distribution (unevenness distribution) information (hereinafter, referred to as “shot topography”) of the surfaces of the shot area SAi on the wafer W is measured. The measuring operation corresponds to a step for obtaining step information of the surface of the object (second object).

In this case, from the shot area SAi on the wafer W, a shot area for measuring a shot topography is selected in advance as a topography measuring shot. If exposure is performed in the scanning exposure system, as shown in FIG. 5, when the exposure area 3 moves relatively in −Y direction with respect to a certain shot area SA7 (the wafer W is scanned in +Y direction), the exposure area 3 moves relatively in +Y direction with respect to the neighboring shot area SA8 (the wafer W is scanned in −Y direction). Moreover, scanning direction of each shot area SAi is determined, so that, for example, total exposure time becomes shortest, and stored as exposure data. Consequently, as one example, four shot areas SA7, SA11, SA21 and SA25 where the wafer W is scanned in +Y direction, are selected as topography measuring shots in a positive scanning direction, and four shot areas SA8, SA12, SA22 and SA26 where the wafer W is scanned in −Y direction, are selected as topography measuring shots in a negative scanning direction. Moreover, scanning direction of the wafer W, when shot topography of each topography measuring shot is measured, is set identical to the scanning direction during scanning exposure, two sets of the below-described correction maps are generated for each scanning direction of the wafer W.

Moreover, it is also preferable to select the topography measuring shots form the entire wafer W without deflection. Moreover, if, for example, it is known from the actual measurement result that there are few difference among measured results of height distribution depending on the scanning directions, one set of the below-described correction map may be generated regardless of the scanning directions by selecting only, for example, four shot areas SA7, SA8, SA25 and SA26 whose scanning directions are positive or negative as the topography measuring shots.

Moreover, together with the topography measuring shots, measure points row to be used for measuring shot topography is selected out of measure points rows 32A to 32E at the focus position in FIG. 3 (A). In the present embodiment, as one example, in order to facilitate arithmetic processing, the central measure points row 32C of the exposure area 3 in FIG. 3 (A) is used for the measurement. However, as for all of the measure points rows (measure points rows 32A, 32B, 32D and 32E in case of FIG. 3 (B)) having possibility to be used during an actual scanning exposure, it is preferable to measure shot topography for each of them. Moreover, in FIG. 3 (B), in case of a measuring shot with a scanning direction of the wafer in +Y direction, measure points rows 32D and 32E are used. Also, in case of a measuring shot with a scanning direction of the wafer in −Y direction, measure points rows 32A and 32B are used. In such a manner, it is preferable to use measure points row used during scanning exposure also during measurement of the shot topography. As above, by switching measure points rows at the focus position used during measurement of the shot topography, depending on the scanning direction of the wafer, accuracy for measuring shot topography increases.

Moreover, in step 104, by driving the XY stage 13 in FIG. 1, a topography measuring shot to be measured next on the wafer W (here, shot area SA7 is selected) is moved below the projection optical system PL. In the next step 105, deflection from the image plane is measured by causing the center of the topography measuring shot to be coincided with a measure point at the center of the measure points row 32C in FIG. 3 (A). In addition, the Z drivers 12A to 12C in FIG. 1 are moved in parallel in the Z direction so that the deflection becomes zero. In this manner, a state of the center of the topography measuring shot becomes a state to be coincided with the image plane of the projection optical system PL.

In the next step 106 (correction map measurement), by driving the XY stage 13 in FIG. 1 and by scanning the entire surface of the topography measuring shot (here, shot area SA7) in +Y direction with respect to the measuring points row 32C in FIG. 3 (A), at each measure point 31 in the measure points row 32C, deflection of a focus position from image planes each corresponding to Y coordinate, and the deflection is stored as data of correction map in the memory device 22 in FIG. 1. In this case, X coordinates of each measure point 31 in the measure points row 32C, when the edge part in −X direction of the exposure area 3 in FIG. 3 (A) is designated as an origin, are designated as m×ΔX (m=1 to 9), and a distance in Y direction when deflection of the topography measuring shot at the measure points row 32C is designated as ΔY. The distance ΔY is set so as to be narrower than the width of the smallest partial shot in the Y direction usually formed in the shot area SAi on the wafer W.

In addition, by using edge parts in −X direction and in −Y direction of the s-th (s=1, 2, . . . ) topography measuring shot as origins of X coordinate and Y coordinate, respectively, X coordinates and Y coordinates in the topography measuring shot are represented by (m×ΔX, n×ΔY) (n=1, 2, . . . ). In this situation, from the deflection measured by the measure points row 32C, deflection Z(s, m, n) with respect to image planes at each point represented by the coordinates (m×ΔX, n×ΔY) in the topography measuring shots can be obtained. The deflection Z (s, m, n) becomes data when the correction map is determined as follows.
Data of the correction map=deflection Z(s,m,n) (1)

Here, deflection Z(l, m, n) (m=1 to 9, n=1, 2, . . . ) measured at the third measure points row 32C in FIG. 3A is obtained with respect to the first topography measuring shot.

FIG. 6 (C) is an enlarged sectional view showing a state where a shot area SA7, the first topography measuring shot, is scanned in +Y direction with respect to the measure points row 32C. As shown in FIG. 6 (C), since the center of the shot area SA7 coincides with the image plane 28, the reference plane of the wafer W substantially coincides with the image plane 28. In addition, since the reference plane 27 is in parallel with planes passing through identical points in each shot area SAi on the wafer W, the partial shots 29A, 29B and 29C each having a different step in the shot area SA7 are substantially in parallel with the reference plane 27, respectively. Moreover, since the measured deflections are substantially the height distribution of the surface of the shot area SA7 expressed by the deflections from the reference plane 27, deflections at respective partial shots 29A to 29C become substantially constant, respectively.

Next, in step 7, it is determined whether or not height distribution with respect to the entire topography measuring shots on the wafer W is measured. Since, at this stage, measurement is not finished, operation returns to step 104, and by repeating the operations in steps 105 and 106 with respect to shot areas SA8, SA11, SA12, SA21, SA22, SA25 and SA26 that are remaining topography measuring shots in FIG. 5, respectively similar to the shot area SA7 (however, the scanning direction reverses alternately), the deflection Z (s, m, n) (s=2 to 8) as height distribution in the shot areas is measured and stored in the memory device 22. Then, when the measurement of the last topography measuring shot in FIG. 5 is finished, operation moves from step 107 to step 108, and end processing of the measuring operation is performed. Specifically, by driving the XY stage 13 in FIG. 1, the wafer W is moved to an exposure starting position.

In next step 109, the correction map calculator in the main control system 8 in FIG. 1 generates a correction map using the deflection Z (s, m, n), data of the correction map in the memory device 22, and stores the generated correction map in the memory device 22.

The correction map is generated for every measure points row (here, the measure points row 32C in FIG. 3 (A)) of the focus position used for measuring, and further generated for every scanning direction (positive or negative) of the topography measuring shots. A set of correction map composed of all of them is handled as a correction map corresponding to shot topography in the entire shot areas on the wafer W.

In other words, one correction map with respect to each measure points row and scanning direction is generated from measured results of each plurality of topography measuring shots, and this is used when scanning and exposing specified shots, being shot area SAi on the wafer W where correction of focus position by the correction map is specified. Which specified shot is specified for each correction map can be determined by the method such as manual setting by an operator, or automatic setting by detecting shots having the same exposure conditions.

Specifically, when a correction map is obtained from deflection Z(s, m, n) in a coordinate (m×ΔX, n×ΔY) in s-th topography measuring shot, first, average value Ave (m, n; Z(s, m, n)) of the deflection Z(s, m, n) in the topography measuring shot is calculated as follows. Here, mnmax is a product of the maximum value of m and the maximum value of n, and symbol Σ represents a sum of the deflection Z (s, m, n) with respect to integers m and n.
Ave(m,n;Z(s,m,n))={ΣZ(s,m,n)}/mnmax (2)
Next, by subtracting the average value Ave (m, n; Z (s, m, n)) from the deflection Z (s, m, n) in s-th topography measuring shot, and deflection Z′ (s, m, n) after offset correction is obtained as follows.
Z′(s,m,n)=Z(s,m,n)−Ave(m,n;Z(s,m,n)) (3)

Next, deflections CZ1 (m, n) and CZ2 (m, n) are obtained, which are respectively the averages of the offset-corrected deflection Z′ (s, m, n) of each measuring shot having positive and negative scanning direction, of the topography measuring shots in FIG. 5. In other words, denoting measuring shots having positive scanning direction as s1-th (s1=1, 3, 5 and 7) measuring shot and measuring shots having negative scanning direction as s2-th (s2=2, 4, 6 and 8) measuring shot, CZ1(m, n) and CZ2(m, n) are represented as follows. Here, symbol Σ(s=s1) represents the sum with respect to measuring shots having positive scanning direction, symbol Σ (s=s2) represents the sum with respect to measuring shots having negative scanning direction, and the numbers of the measuring shots having positive and negative scanning direction are designated by N, respectively.
CZ1(m,n)={Σ(s=s1)Z′(s,m,n)}/N (4)
CZ2(m,n)={Σ(s=s2)Z′(s,m,n)}/N (5)

In this manner, deflections CZ1(m, n) and CZ2 (m, n) at coordinate (m×ΔX, n×ΔY) that is an average coordinate among the measuring shots after being subjected to offset correction in the topography measuring shots, become correction maps having positive and negative scanning direction with respect to the measure points row 32C in FIG. 3 (A), respectively. The correction maps are stored in the memory device in FIG. 1, and, if required, supplied to the autofocus controller in the main control system 8. The correction maps can also be considered as step information of the surface of the object (second object). An example of the correction maps CZ1 (m, n) and CZ2(m, n) when the value of integer m is set to a predetermined value, is represented in FIGS. 6 (D) and 6 (E), respectively. In addition, traverse axes in FIGS. 6 (D) and 6 (E) are Y coordinate (maximum value is SY) represented by n×ΔY. During the scanning exposure, the correction map CZ1 (m, n) is used for the shot areas having positive scanning direction, and the correction map CZ2(m, n) is used for the shot areas having negative scanning direction.

During the operation in step 109, when averaging deflections Z′ (s, m, n) in formula (4) and (5) among measuring shots, it is also possible to obtain the average value using the remaining data after eliminating data exceeding three times of standard deviation (3σ) in the parent population of the deflections Z′ (s, m, n). In this manner, by eliminating the effect of characteristic components to specific measuring shots, foreign matters, for example, such as contaminants, accuracy for generating correction maps improves. Of course, the determining standard for rejection is not required to be limited to 3σ, it is also possible to use arbitrary setting value such as standard deviation (σ) or six times of standard deviation (6σ).

In the operation for generating the correction maps in the present embodiment, since correction treatment with respect to tilts in each shot area SAi on the wafer W is not performed at all, the arithmetic processing is easy. In addition, in step 103, since the data of the deflection Z(s, m, n) for generating correction maps is measured in a state the attitude of the wafer table 11 is corrected by an angle (−θxg and −θyg), the correction maps reflect the global tilt angle (θxg, θyg) of the wafer W.

In addition, the above correction maps may be generated by generating correction maps with respect to a plurality of head wafers of one lot to average the results. In this case, it is preferable to measure the flatness (step 101), calculate the global tilt angle (step 102), and correct the attitude of the wafer table 11 (step 103) of the wafer in FIG. 8, for each wafer. However, when tilt components specific to the wafer are sufficiently small as compared to allowable error of correction, measurement for generating correction map may be performed, for example, only for a head wafer.

Next, in order to perform the scanning exposure on the wafer W using the correction maps, operation moves to step 110, where a reticle R to be transferred is loaded on the reticle stage 4 in FIG. 1, and then alignment of the reticle R is performed. In the next step 111, to the main control system 8, for example, an operator designates a partial shot in each shot area SAi on the wafer W, on which a pattern image of the reticle R is transferred. In response to this, in step 112, the autofocus controller in the main control system 8 reads out the correction maps generated in step 109 from the memory device 22. Then, the autofocus controller, using the position of the partial shot to be exposed and the correction maps, determines the correction values of the focus positions to be measured at each measure points of the multipoint AF sensors (19A and 19B).

In this case, in FIG. 10 showing shot area SAi of the wafer W, if a pattern image of the reticle R is to be transferred on the lowest partial shot 29A, in the autofocus controller, if the values corresponding to the partial shot 29A of the correction maps CZ1(m, n) and CZ2(m, n) in FIG. 6 (D) and FIG. 6 (E), are designated as −ZA1 and −ZA2, correction value (+) and correction value (−) are set as follows.
Correction value(+)=CZ1(m,n)−(−ZA1) (6)
Correction value(−)=CZ2(m,n)−(−ZA2) (7)

After that, after the scanning exposure of the wafer W is started in step 113, in the autofocus controller, the Z drivers 12A to 12 C are driven in the autofocus system, so that focus position obtained by subtracting the correction value in formula (6) or (7), depending on the scanning direction, from the focus position measured at each measure point of the multipoint AF sensors (19A and 19B), becomes zero as average value.

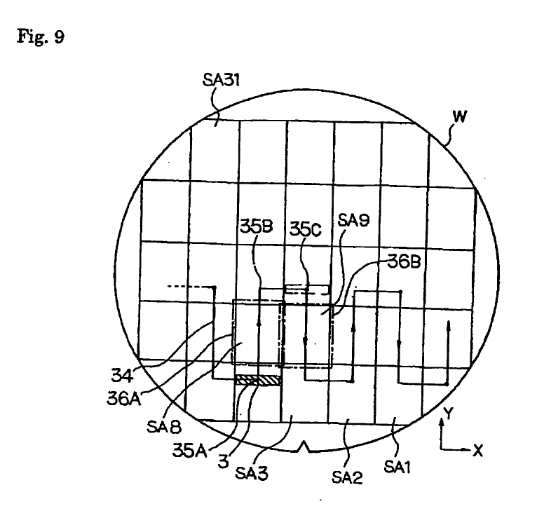

FIG. 9 shows path 34 of the relative movement of the exposure area 3 during the scanning exposure with respect to the wafer W, in FIG. 9, with respect to the shot area SA8, the exposure area 3 moves relatively toward +Y direction from position 35A to position 35B (the wafer W moves in −Y direction), and, with respect to the neighboring shot area SA9, the exposure area 3 moves relatively toward −Y direction from position 35C (the wafer W moves in +Y direction). Consequently, during the scanning exposure of the shot area SA8, formula (7) is used as a correction value of the focus position, during the scanning exposure of the shot area SA9, formula (6) is used as a correction value of the focus position, and pattern images 36A and 36B (in practice, among them, images of parts corresponding to the partial shot 29A in FIG. 10) of the reticle R are transferred, respectively. The autofocus operation is continued until the scanning exposure to the entire shot areas on the wafer W is finished in step 115. After that, in step 116, the second and subsequent wafers of one lot are subjected to exposure treatment.

In this case, parts corresponding to the partial shot area 29A of the correction maps CZ1(m, n) and CZ2(m, n) in FIGS. 6 (D) and 6 (E) in the present embodiment, are substantially a constant value (flat). Consequently, by performing autofocusing during the scanning exposure, as shown in FIG. 10, the image plane 28 of the projection optical system PL is focused on the partial shot 29A in the shot area SAi being substantially in parallel with each other. Accordingly, on the partial shot 29A, even if, a fine pattern such as, for example, a contact hole, is transferred in high resolution and in high fidelity of transformation. Similarly, for example, when a pattern is transferred on the other partial shot 29B or 29C having different heights, the pattern is also transferred in high resolution and in high fidelity of transformation. Accordingly, even if the height distribution in the shot area SAi is deflected in the scanning direction, and has an asymmetric distribution in the scanning direction, uniformity of size and line width of the pattern transferred on the entire surfaces of the shot area SAi, improves.

Correspondingly, FIG. 11 shows the case where, when the height distribution in the shot area SAi is measured, an average plane of the shot area SAi is used as a reference plane. The correction maps generated in the case, become planes tilt with respect to the reference plane. Consequently, when autofocusing is performed by correcting the measured values of the focus positions based on the correction maps, as shown in FIG. 11, since exposure is performed in a state where the image plane 28 of the projection optical system PL is tilt with respect to the partial shot 29A to be exposed, the uniformity of the size and line width of the transferred pattern degrades.

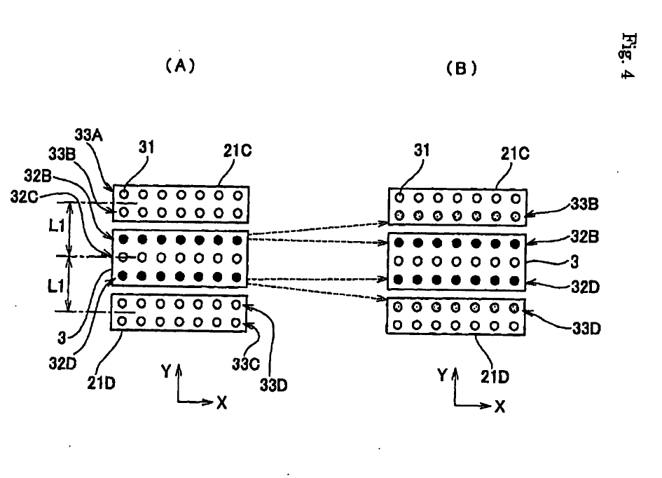

In addition, as for the arrangement of the measure points for focus positions on the wafer, an arrangement as in FIG. 4 (A) is also possible.

In FIG. 4 (A), three measure points rows 32B, 32C and 32D are set in the exposure area 3, which are composed of seven measure points 31 respectively arranged in the X direction (non-scanning direction) at a constant pitch, and arranged in the Y direction (scanning direction) at an equal distance, and the central measure points row 32C passes through the optical axis AX of the projection optical system PL in FIG. 1. Moreover, two measure points rows 33A and 33B composed of seven measure points 31 respectively arranged in the X direction at a constant pitch in the pre-read area 21C in +Y direction with respect to the exposure area 3 are set, and two measure points 33C and 33D composed of seven measure points 31 respectively arranged in the X direction at a constant pitch in the pre-read area 21D in −Y direction with respect to the exposure area 3 are set. Distances between the central measure points row 32C and the centers of the pre-read areas 21C and 21D in the scanning direction are set to be L1 respectively. On the seven columns×seven rows measure points 31, slit images are projected from the multipoint AF sensors (19A and 19B) in FIG. 1 respectively, and the focus positions of respective measure points 31 are measured at a predetermined sampling rate.

In this case, in FIG. 4 (A), when the scanning exposure is performed by moving the wafer in −Y direction with respect to the exposure area 3, the drive amount of the Z drivers 12A to 12C in FIG. 1 is set based on the information of the focus positions in the measure points in the exposure area 3 and the pre-read area 21C at the side in +Y direction. Meanwhile, in FIG. 4 (A), when the scanning exposure is performed by moving the wafer in +Y direction with respect to the exposure area 3, by continuously detecting focus positions in the measure points in the exposure area 3 and focus positions in the measure points in the pre-read area 21D at the side in −Y direction, the surface of the wafer is focused on the image plane in the autofocus system.

Also, in the arrangement of the measure points 31 in FIG. 4 (A), when the height distribution of the surface of the wafer W is obtained in advance, as one example, when the wafer W is moved in −Y direction, the focus position of the wafer W may be measured by only the measure points of the measure points row 32B in +Y direction in the exposure area 3 in FIG. 4 (A), and when the wafer W is moved in +Y direction, the focus position of the wafer W may be measured by only the measure points of the measure points row 32D in −Y direction in the exposure area 3 in FIG. 4 (A). In addition, during the scanning exposure, when the wafer W is scanned in −Y direction, as shown in FIG. 4 (B), the focus position of the wafer W may be measured by only the measure points 31 of one measure points row 33B in the pre-read area 21C in +Y direction and the measure points row 32B in the exposure area 3 in +Y direction. In this case, when the wafer W is scanned in +Y direction, as shown in FIG. 4 (B), the focus position of the wafer W is measured by only the measure points 31 of one measure points row 33D in the pre-read area 21D in −Y direction and the measure points row 32D in the exposure area 3 in −Y direction. This facilitates the arithmetic processing easier than the case when focus positions of all measure points 31 are used, with few degradation of follow-up accuracy. Moreover, by causing the number of the measure points for focus positions, when measuring the height distribution of wafer surface, to be fewer than during the scanning exposure, it becomes possible to facilitate the arithmetic processing when measuring the height distribution.

Moreover, according to the arrangement of the measure points 31 of focus positions in FIG. 4 (A), measure point rows (33A, 33B, 33C and 33D) to be used for pre-reading the focus positions in the pre-read areas 21C and 21D can be selected depending on, for example, scanning speed of the wafer. As one example, when sensitivity of the photoresist on the wafer is high (fewer exposure amount is acceptable) and the scanning speed of the wafer is high, by using the measure points row 33A (or 33C) being most apart from the exposure area 3 in the scanning direction for pre-reading, the follow-up accuracy can be maintained to be high. Accordingly, when the range of the scanning speed of the wafer is large, sometimes, the arrangement of the measure points 31 in FIG. 4 (A) is more advantageous than the arrangement of the measure points 31 in FIG. 3 (A).

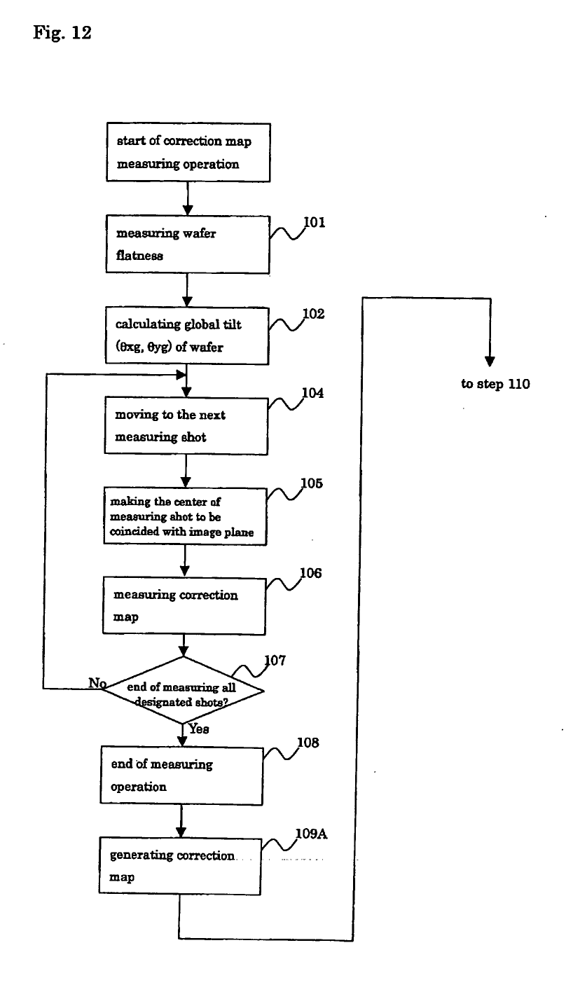

Next, referring to the flow chart in FIG. 12, the second embodiment of the present invention will be described. A scanning exposure apparatus used in this embodiment is the same as the one shown in FIGS. 1 to 3 in the first embodiment, however, the exposure operation is different. In the present embodiment, the wafer to be exposed is also the wafer W in FIG. 5, and, in FIG. 12, operations corresponding to those in FIG. 8 are denoted by attaching the same symbols and their detailed description is eliminated. As shown in steps 101 and 102 in FIG. 12, the exposure operations of the present embodiment are also similar to those of the first embodiment in FIG. 8, to the flatness measurement of the wafer W and the calculation of the global tilt angle (θxg, θyg) of the wafer W. However, in the present embodiment, by abbreviating the attitude correction operation of the wafer table 11 (step 103) in the first embodiment in FIG. 8, the operation is moved to step 104 in FIG. 12, and in steps 104 to 107, the height distribution measurement of the surfaces of the shot area SAi on the wafer W (correction maps measurement) is performed. As the results, in the present embodiment also, the deflection Z(s, m, n) from the image plane can be obtained corresponding to the coordinate (m×ΔX, n×ΔY) in the s-th (s=1, 2, . . . ) topography measuring shot. The deflection Z(s, m, n) is also used as data when the correction maps are determined as follows.
Data of correction maps=deflection Z(s,m,n) (11)

The deflection Z (s, m, n) is different from the deflection Z (s, m, n) in formula (1) in the first embodiment by the global tilt angle (θxg, θyg). Consequently, in the present embodiment, after the measurement operation is finished, operation is moved to step 109A in FIG. 12 corresponding to step 109 in FIG. 8, through step 108, and by balancing off the global tilt angle (θxg, θyg) in the data by means of calculation, correction maps are generated. The operation is a process for correcting the step information obtained in steps 104 to 107 based on the tilt information obtained in steps 101 and 102.

Specifically, in the correction map calculator (arithmetic device) in the main control system 8 in FIG. 1, when the correction maps are obtained from the deflection Z (s, m, n) at the coordinate (m×ΔX, n×ΔY) in the s-th topography measuring shot, first average value Ave(m, n; Z(s, m, n)) of the deflections Z (s, m, n) in the topography measuring shots, is calculated from the above formula (2).

Next, by subtracting the deflection of the global tilt angle (θxg, θyg) and the average value Ave(m, n; Z(s, m, n)) from the deflection Z(s, m, n) in s-th topography measuring shot, deflections Z′ (s, m, n) after tilt angle and offset correction are obtained as follows. Here, if the values of integers m and n at the center of the topography measuring shots are respectively denoted as mc and nc, the deflection (ΔZxg (m, n), ΔZyg (m, n)) of the tilt angle (θxg, θyg) (rad) at the coordinate (m×ΔX, n×ΔY) becomes (tilt angle×distance) as follows.
ΔZxg(m,n)=θxg×(n−nc)×ΔY (12)
ΔZyg(m,n)=θyg×(m−mc)×ΔX (13)

Using these deflections, the defraction Z′ (s, m, n) after tilt angle and offset correction, becomes as follows.
Z′(s,m,n)=Z(s,m,n)−{ΔZxg(m,n)+ΔZyg(m,n)+Ave(m,n;Z(s,m,n))} (14)
Next, deflections CZ1(m, n) and CZ2(m, n) can be obtained from formulas (4) and (5), which are respectively averages of the offset-corrected deflections Z′ (s, m, n) of every measuring shots having positive scanning direction and having negative scanning direction, in the topography measuring shots in FIG. 5. Operations except for this operation are similar to those of the first embodiment in FIG. 8, subsequent to step 109A in FIG. 12, operation moves to step 110 in FIG. 8, and then the wafer W is subjected to the scanning exposure.

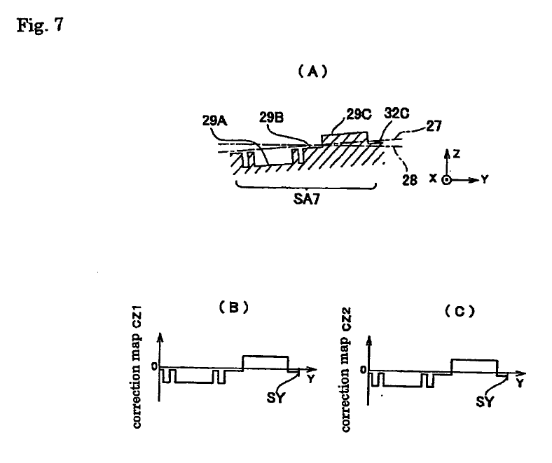

In this case, FIG. 7 (A) shows measurement operation of the height distribution of the shot area SA7 in step 106 in FIG. 12, and, in FIG. 7 (A), the reference plane 27 passing through an identical point in each shot area on the wafer W is in parallel with the partial shots 29A to 29C in the shot area SA7. However the reference plane 27 is tilt with respect to the image plane 28 of the projection optical system PL by the global tilt angle. In the state, using the image plane 28 as a reference of the measurement, the height distribution of the shot area SA7 is measured. Since deflection due to the tilt angle between the image plane 28 and the reference plane 27 is balanced out by the arithmetic in formula (14), the finally obtained correction maps CZ1(m, n) in FIG. 7 (B) and CZ2(m, n) in FIG. 7 (B) come to be identical to those in FIGS. 6 (D) and 6 (E) of the first embodiment. Accordingly, during the scanning exposure, by performing autofocusing the correction maps, exposure can be performed in the state that, for example, the partial shot area 29A in the shot area SAi in FIG. 10 is caused to coincide with the image plane 28 in parallel. Accordingly, even if the height distribution in the shot area SAi deflects in the scanning direction, and thereby has an asymmetric distribution in the scanning direction, uniformity of the size and line width of the pattern transferred on the entire surfaces of the shot area SAi improves. In the operation of the present embodiment, though arithmetic processing is complicated, it is possible to shorten times for obtaining the correction maps, because attitude correction of the wafer table 11 is eliminated.

Further, when, using the scanning exposure apparatus of the above-mentioned embodiment, a semiconductor device is manufactured on the wafer, the semiconductor device is manufactured through the steps of: designing function and characteristics of the device; manufacturing a reticle based on this step, manufacturing a wafer from silicon material; exposing a reticle pattern on the wafer by performing alignment by the scanning exposure apparatus of the above-mentioned embodiment; forming a pattern by performing etching etc.; assembling devices (dicing process, bonding process, and packaging process are included); and inspection etc.

In addition, the scanning exposure apparatus of the above-mentioned embodiment can be manufactured, by incorporating the illumination optical system and projection optical system composed of a plurality of lenses, and performing optical alignment, and by installing the reticle stage and wafer stage composed of a large number of mechanical components to the exposure apparatus body, connecting wirings and pipes to the body, and further performing total adjustment (electric adjustment and operation check etc.). Incidentally, it is desirable to manufacture the projection exposure apparatus in a clean room where temperature and cleanliness etc. are controlled.

Moreover, the present invention can be applied not only to the scanning exposure type projection exposure apparatus (scanning exposure apparatus), but also to a step-and-repeat type (batch exposure type) projection exposure apparatus. Further, the present invention can also be applied to a liquid immersion type exposure apparatus disclosed in, for example, international publication (WO) No. 99/49504 pamphlet etc. When the present invention is applied to the liquid immersion type exposure apparatus, during measuring height distribution of the wafer surface (step information), it is not always required to supply liquid between the wafer and the projection optical system.

Furthermore, the exposing light (exposing beam) is not limited to ultraviolet light having a wavelength of an order of 100 to 400 nm, rather, for example, EUV light (Extreme Ultraviolet Light) in a soft X-ray region (wavelength of 5 to 50 nm) generated from a laser plasma light source, or an SOR (Synchrotron Orbital Radiation) ring may be used. In the EUV exposure apparatus, the illumination optical system and the projection optical system are composed of only a plurality of reflection optical elements, respectively.

It is to be noted that the application of the exposure apparatus of the present invention, is not limited to an exposure apparatus for manufacturing a semiconductor device, rather, it can also be widely applied to, for example, an exposure apparatus for a liquid crystal display element formed on a square glass plate, or for a display device such as plasma display device; or to an exposure apparatus for manufacturing various kinds of devices such as an image pickup element (CCD etc.), a micromachine, a thin film magnetic head, and a DNA chip. Further, the present invention can be applied to exposure process (exposure apparatus) when a mask (photomask or reticle etc.) on which a mask pattern of various kinds of devices is formed is manufactured using a photolithography process.

The present invention is not limited to the above-mentioned embodiments, and the invention may, as a matter of course, be embodied in various forms without departing from the gist of the present invention. Furthermore, the entire disclosure of Japanese Patent Application No. 2004-074021 filed on Mar. 16, 2004 including description, claims, drawings and abstract are incorporated herein by reference in its entirety.

### INDUSTRIAL APPLICABILITY

According to the present invention, since focusing accuracy when an object is exposed in, for example, the scanning exposure system, can be improved, uniformity of the size and the line width of a pattern transferred on the entire surfaces of each sectional area (shot area) on the object can be improved.

1. A step measuring method for obtaining step information on a surface of an object, comprising:
a first step of obtaining tilt information on the surface of the object;
a second step of changing the tilt angle of the object based on the tilt information obtained in the first step; and
a third step of obtaining step information on the surface of the object while moving the tilt angle changed object.

2. A step measuring method for obtaining step information on a surface of an object, comprising:
a first step of obtaining tilt information of the surface of the object;
a second step of obtaining step information of the surface of the object while moving the object; and
a third step of correcting the step information obtained in the second step based on the tilt information obtained in the first step.

3. A step measuring method as recited claim 2, wherein
the surface of the object is divided into a large number of sectional areas mutually having a same shape, and
the first step includes a measuring step of measuring height information of measure points that are mutually in a same positional relationship in a plurality of the sectional areas selected from the large number of the sectional areas of the object, and a calculating step of obtaining the tilt information on the surface of the object based on the height information measured in the measuring step.

4. An exposure method for scanning and exposing a second object by illuminating the second object via a first object with an exposure beam and by synchronously moving the first object and the second object, comprising:
a first step of obtaining tilt information on the surface of the second object;
a second step of changing the tilt angle of the second object based on the tilt information obtained in the first step; and
a third step of obtaining step information on the surface of the second object while moving the tilt angle changed object.

5. An exposure method for scanning and exposing a second object by illuminating the second object via a first object with an exposure beam and by synchronously moving the first object and the second object, comprising:
a first step of obtaining tilt information of the surface of the second object;
a second step of obtaining step information, which is to be used in scanning and exposing the second object, of the surface of the second object while moving the second object; and
a third step of correcting the step information obtained in the second step based on the tilt information obtained in the first step.

6. An exposure method as recited in claim 4, wherein
the surface of the second object is divided into a large number of sectional areas on each of which a pattern of the first object is to be transferred, and
the first step includes a measuring step of measuring height information of measure points that are mutually in a same positional relationship in a plurality of the sectional areas selected from the large number of the sectional areas of the second object, and a calculating step of obtaining the tilt information on the surface of the object based on the height information measured in the measuring step.

7. An exposure method as recited in claim 4, further comprising:
a fourth step of scanning and exposing the second object, while focusing the surface of the second object onto an image plane of a pattern of the first object, based on information obtained by measuring height information on the surface of the second object while synchronously moving the first object and the second object and correcting the measured height information using the step information corrected in the third step.

8. A step measuring apparatus for obtaining step information on a surface of an object, comprising:
a stage device which moves at least in a first direction while holding the object and controls at least one of a height and a tilt angle of the object; a sensor which measures height information of the object held by the stage device; and
an arithmetic device which obtains tilt information of the surface of the object based on the height information measured by the sensors when the object is moved via the stage device, and obtains the step information on the surface of the object, based on the tilt information and the height information measured by the sensor when the object is moved in the first direction via the stage device.

9. A step measuring apparatus as recited in claim 8, wherein
the arithmetic device, after changing the tilt angle of the object via the stage device based on the tilt information of the surface of the object, obtains the step information of the surface of the object based on the height information measured by the sensor when the object is moved in the first direction via the stage device.

10. A step measuring apparatus as recited in claim 8, wherein
the arithmetic device, after obtaining the tilt information of the surface of the object, obtains the step information of the surface of the object by correcting the height information, by using the tilt information, of the object measured by the sensor when the object is moved in the first direction via the stage device.

11. An exposure apparatus for scanning and exposing a second object by illuminating the second object via a first object with an exposure beam and by synchronously moving the first object and the second object, comprising:
a stage device which holds the second object and moves the second object at least in a first direction, and controls at least one of a height and a tilt angle of the second object;
a sensor which measures height information of the second object held by the stage device; and
an arithmetic device which obtains tilt information of a surface of the second object based on the height information measured by the sensor when the second object is moved via the stage device, and obtains step information on the surface of the second object based on the tilt information and the height information measured by the sensor when the second object is moved in the first direction via the stage device.

12. An exposure apparatus as recited in claim 11, wherein
the arithmetic device obtains, after changing the tilt angle of the second object via the stage device based on the tilt information of the surface of the second object, the step information of the surface of the second object based on the height information measured by the sensor when the second object is moved in the first direction via the stage device.

13. An exposure apparatus as recited in claim 11, wherein
the arithmetic device obtains, after obtaining the tilt information of the surface of the second object, the step information of the surface of the second object by correcting the height information, by using the tilt information, of the second object measured by the sensor when the second object is moved in the first direction via the stage device.

14. An exposure apparatus as recited in claim 11, wherein
the surface of the second object is divided into a large number of sectional areas on each of which a pattern of the first object is to be transferred, and
the arithmetic device obtains the tilt information of the second object based on height information measured by the sensor at measure points that are mutually in a same positional relationship in a plurality of sectional areas selected from the large number of sectional areas of the second object.

15. An exposure apparatus for scanning and exposing a second object by illuminating the second object via a first object with an exposure beam and by synchronously moving the first object and the second object, comprising:
a stage device which holds the second object and moves the second object at least in a first direction, and controls at least one of a height and a tilt angle of the second object;
a sensor which measures height information of the second object held by the stage device;
a memory device which stores step information on a surface of the second object corrected based on tilt information of the surface of the second object; and
a control device which controls, during scanning and exposing the second object, an attitude of the second object by driving the stage device based on the step information stored in the memory device and the height information measured by the sensor.

16. An exposure apparatus as recited in claim 15, wherein
the surface of the second object includes a plurality of planes having different heights from each other, and
the control device controls the attitude of the second object by driving the stage device such that a predetermined plane selected from the plurality of planes having different heights from each other is focused on an image plane of a pattern of the first object.
